(19) United States
(12) Patent Application Publication
(10) Pub. No.: US 2024/0406703 A1
(43) Pub. Date: Dec. 5, 2024

(54) DISCOVERY SIGNAL BROADCASTING FOR A NON-STATIONARY RELAY

(71) Applicant: QUALCOMM Incorporated, San Diego, CA (US)

(72) Inventors: Qiaoyu LI, Beijing (CN); Kangqi LIU, San Diego, CA (US); Chao WEI, Beijing (CN); Hao XU, Beijing (CN)

(21) Appl. No.: 18/695,749

(22) PCT Filed: Nov. 30, 2021
(86) PCT No.: PCT/CN2021/134580

§ 371 Date: Mar. 26, 2024

(51) Int. Cl. H04W 8/00; H04L 1/00; H04W 16/28; H04W 64/00

(52) U.S. Cl. CPC H04W 8/005; H04L 1/0003; H04W 16/28; H04W 64/003

(57) ABSTRACT

Certain aspects provide a method for wireless communications by an apparatus. The method includes determining whether to broadcast a discovery signal based at least in part on a geographical location of the apparatus. The method further includes broadcasting the discovery signal when it is determined to broadcast the discovery signal.

### BACKGROUND

### Field

Aspects of the present disclosure relate to wireless communications, and more particularly, to techniques for discovery signaling.

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

In one aspect, a method for wireless communications by an apparatus includes determining whether to broadcast a discovery signal based at least in part on a geographical location of the apparatus; and broadcasting the discovery signal when it is determined to broadcast the discovery signal. Other aspects provide: an apparatus comprising a memory and a processor coupled to the memory that are configured to cause the apparatus to perform the preceding method; an apparatus with one or more means for performing the preceding method; or one or more non-transitory computer readable media storing instructions, that when executed by an apparatus, cause the apparatus to perform the preceding method.

In one aspect, a method for wireless communication by a user equipment (UE) includes receiving, from a base station, side information indicating one or more parameters for receiving a discovery signal in one or more geographical areas without cellular coverage available; and receiving, from an apparatus, the discovery signal in a geographical area of the one or more geographical areas without cellular coverage available based on the side information. Other aspects provide: a UE comprising a memory and a processor coupled to the memory that are configured to cause the UE to perform the preceding method; a UE with one or more means for performing the preceding method; or one or more non-transitory computer readable media storing instructions, that when executed by a UE, cause the UE to perform the preceding method.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 depicts an example of a non-stationary relay extending the coverage area of a network.

FIG. 5 illustrates a call-flow diagram for communication in a network via a non-stationary relay of FIG. 4.

FIG. 6 is a block diagram of a base station and relay of FIG. 4.

FIGS. 7 through 8 show examples of methods for wireless communication according to aspects of the present disclosure.

FIGS. 9 through 10 show examples of communications devices according to aspects of the present disclosure.

### DETAILED DESCRIPTION

Aspects of the present disclosure provide apparatuses, methods, processing systems, and computer-readable mediums for broadcasting a discovery signal from a non-stationary relay based at least in part on a geographical location of the relay.

In certain aspects, a relay may extend cellular coverage of a network into geographical locations not covered by one or more base stations (BSs). For example, a relay may allow a BS and a user equipment (UE) to communicate via the relay. For downlink, the BS may transmit downlink signals (e.g., beamformed toward the relay), the relay may receive the downlink signals, and the relay may further re-transmit the downlink signals as downlink signals or sidelink signals (e.g., beamformed toward the UE). For uplink, the UE may transmit signals (e.g., beamformed toward the relay) as uplink signals or sidelink signals, the relay may receive the signals, and the relay may further re-transmit the signals (e.g., beamformed toward the BS) as uplink signals. Accordingly, even if the UE is not within cellular coverage of the BS, it may be within the extended cellular coverage provided by the relay.

In certain aspects, in order for a UE to access a relay, the relay may transmit a discovery signal. The UE, when in the coverage area of the relay, may receive the discovery signal and determine it is within the coverage area of the relay. Accordingly, the UE can transmit a message to the relay, for the relay to further send to a BS of the network.

In certain aspects, a relay may be non-stationary, in that it is capable of moving. For example, the relay may be part of an aircraft or other vehicle. Though certain aspects herein are described with respect to an aircraft, and in particular an airplane, it should be noted that the described techniques may be similarly used for other suitable apparatuses acting as a relay.

When a relay is non-stationary, there may be times that it is within a geographical area where there is not cellular coverage, such as from a BS. However, there may also be times that the relay is within a geographical area where there is cellular coverage from one or more BSs. In such circumstances, when the relay is within a geographical area where there is cellular coverage from one or more BSs, transmission of a discovery signal by the relay may cause interference in the network. For example, the relay may be configured to transmit the discovery signal at the same frequency as used by BSs and UEs in the network for cellular communication. Accordingly, transmission of the discovery signal in an area where there are communications between BSs and UEs may cause interference with such communications.

Accordingly, certain aspects described herein provide techniques to reduce potential interference to a communication network caused by a relay transmitting (e.g., broadcasting) a discovery signal. In particular, in certain aspects, the relay determines whether to broadcast a discovery signal based at least in part on a geographical location of the relay, and broadcasts the discovery signal when it is determined to broadcast the discovery signal. For example, when the geographical location of the relay is over an area identified as being a geographical area without cellular coverage available, the relay may transmit the discovery signal. In another example, when the geographical location of the relay is over an area identified as being a geographical area with cellular coverage available, the relay may refrain from transmitting the discovery signal. Such techniques help reduce interference to devices of a network in areas with cellular coverage, while still providing discovery mechanisms for relays in areas without cellular coverage. In certain aspects, a relay is considered within a particular geographical area when physically within the geographical area.

In certain aspects, a relay is considered within a geographical area when a coverage area of the relay (e.g., using an omni-directional beam, using a directional beam, etc.) is within/overlaps with the geographical area. In certain aspects, if a relay is within both a geographical area with cellular coverage and a geographical area without cellular coverage, it refrains from transmitting a discovery signal. In certain aspects, if a relay is within both a geographical area with cellular coverage and a geographical area without cellular coverage, it transmits a discovery signal (e.g., omni-directionally or beamformed to avoid the geographical area with cellular coverage).

### Introduction to Wireless Communication Networks

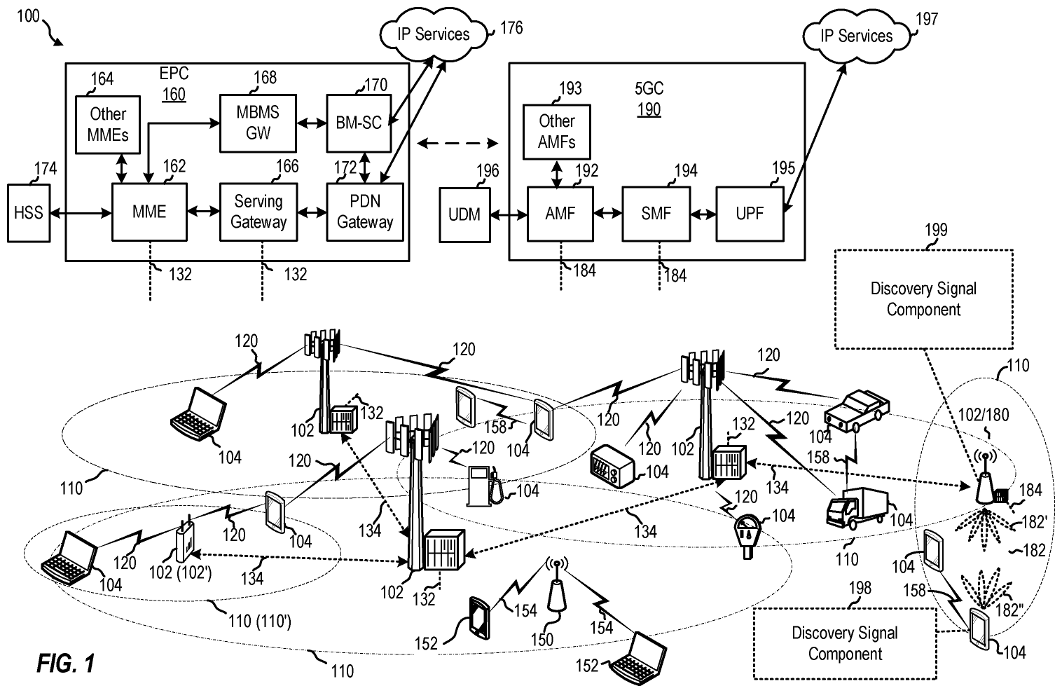

FIG. 1 depicts an example of a wireless communications system 100, in which aspects described herein may be implemented.

Generally, wireless communications system 100 includes various network entities (alternatively, network elements or network nodes), which are generally manageable logical entities associated with, for example, a communication device and/or a communication function associated with a communication device. For example, various functions of a network as well as various devices associated with an interacting with a network may be considered network entities.

In the depicted example, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services, each of which may be considered a network entity.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes discovery signal component 199, which may be configured to aid a relay in determining whether to transmit a discovery signal, as discussed herein. Wireless network 100 further includes discovery signal component 198, which may be used configured to receive a discovery signal from a relay, as discussed herein. Further, a relay may similarly include discovery signal component 199 or a similar component.

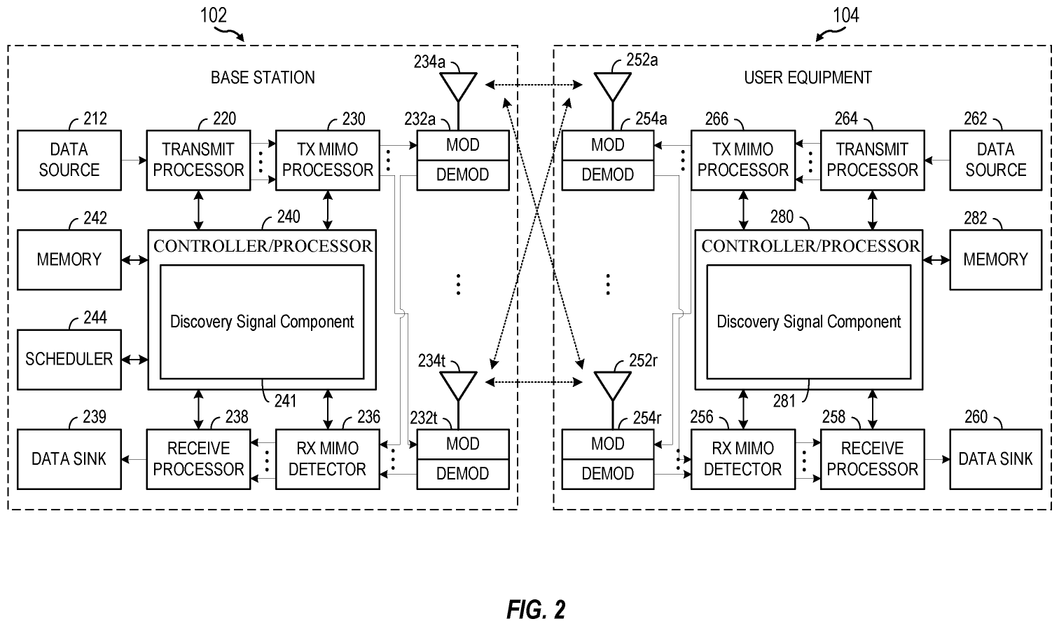

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes discovery signal component 241, which may be representative of discovery signal component 199 of FIG. 1. Notably, while depicted as an aspect of controller/processor 240, discovery signal component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes discovery signal component 281, which may be representative of discovery signal component 198 of FIG. 1. Notably, while depicted as an aspect of controller/processor 280, discovery signal component 281 may be implemented additionally or alternatively in various other aspects of user equipment 104 in other implementations. A relay as discussed herein may have similar components as shown as one or more of UE 104 or BS 102.

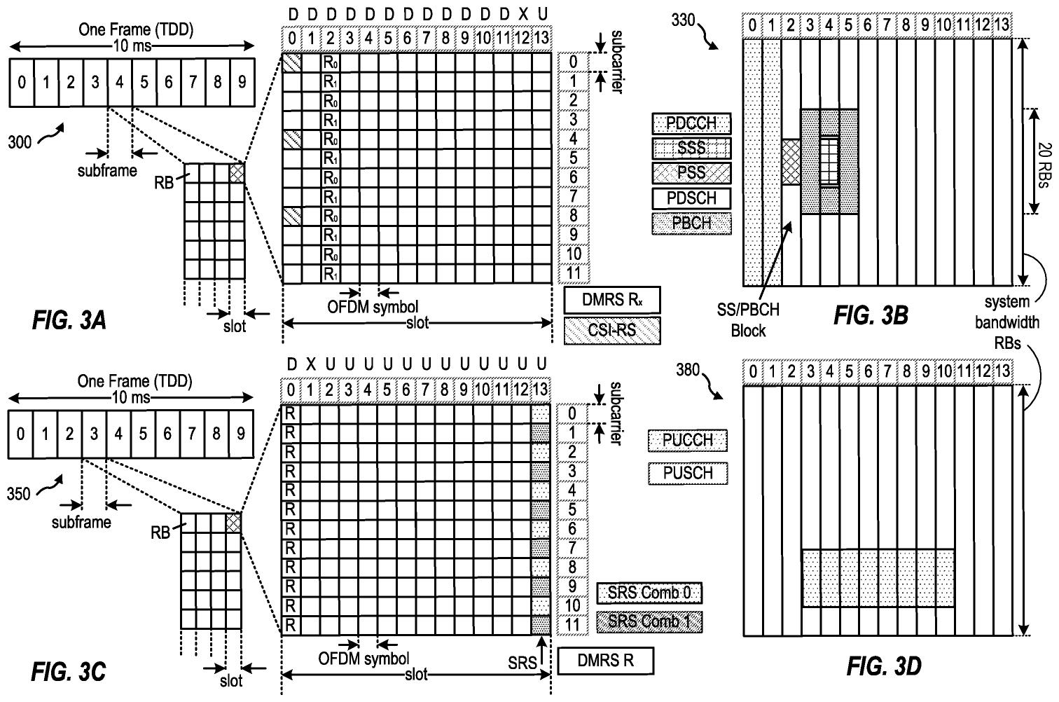

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

Aspects Related to Broadcasting a Discovery Signal from a Non-Stationary Relay

As noted, aspects of the present disclosure provide apparatuses, methods, processing systems, and computer-readable mediums for broadcasting a discovery signal from a non-stationary relay based at least in part on a geographical location of the relay. Though certain aspects herein are described with respect to an aircraft, and in particular an airplane, it should be noted that the described techniques may be similarly used for other suitable apparatuses acting as a relay.

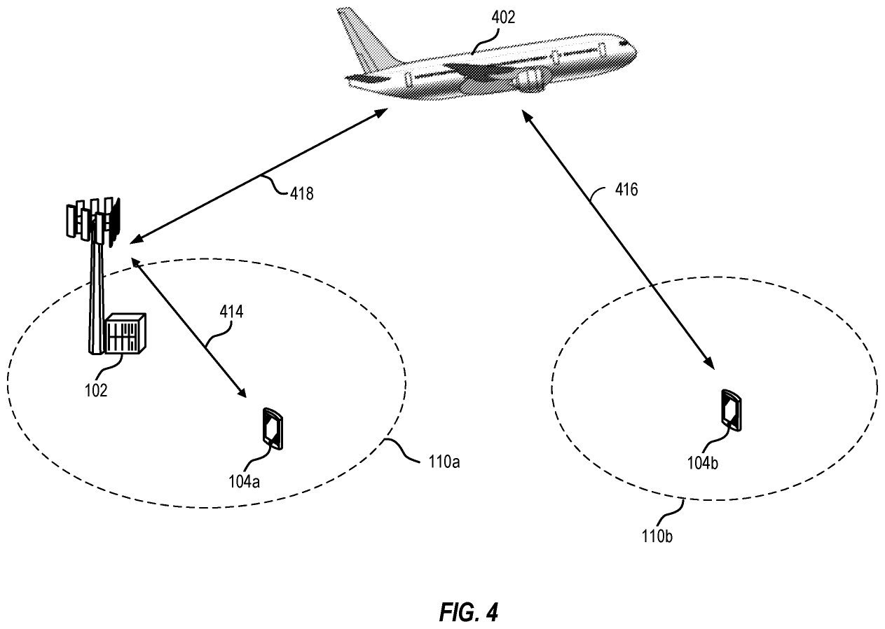

FIG. 4 depicts an example of a non-stationary relay extending the coverage area of a network. As shown, BS 102 wirelessly communicates with UE 104a in geographical coverage area 110a via a link 414. In particular, BS 102 provides coverage for a wireless communication network in geographical coverage area 110a. Though not shown, the network may include additional BSs 102 providing coverage for the wireless communication network in additional geographical areas. As shown, UE 104b is outside the geographical coverage area of the network, in that it is outside the coverage area of any BS 102.

A non-stationary relay 402, depicted as an airplane, is shown within communication range of BS 102 (e.g., within the coverage area 110a of BS 102). For example, the BS 102 may include one or more up-tilting antennas that can communicate upward to non-stationary relay 402, and relay 402 may include one or more bottom/side antennas that can communicate downward. Relay 402 and BS 102 may communicate via a link 418. In certain aspects, communications between relay 402 and BS 102 are beamformed, such as using one or more directional beams. For example, relay 402 may use one or more receive beams to receive signals from BS 102, and/or one or more transmit beams to transmit signals to BS 102. Similarly, in an example, BS 102 may use one or more receive beams to receive signals from relay 402, and/or one or more transmit beams to transmit signals to relay 402. In certain aspects, one or more of BS 102 and relay 402 may use an omni-directional beam for transmission and/or reception.

The non-stationary relay 402 may include similar components as shown in FIG. 2 as BS 102 and/or UE 104. For example, a controller/processor (e.g., similar to controller/processor 240 and/or 280) of relay 402 may include a discovery signal component configured to perform one or more operations as discussed herein for broadcasting a discovery signal from a non-stationary relay based at least in part on a geographical location of the relay.

The non-stationary relay 402 is able to relay signals between BS 102 and one or more additional coverage areas, such as one or more coverage areas outside the coverage area of any BS 102 of the network (e.g., referred to as extended coverage areas). For example, when using beamforming, different transmit and/or receive beams may be used by relay 402 to relay signals between the BS 102 and different extended coverage areas. As shown, relay 402 is able to extend coverage of the network to an extended coverage area 110b by relaying signals between BS 102 and extended coverage area 110b. Accordingly, relay 402 is able to extend the coverage of the network to UE 104b in extended coverage area 110b. As shown, relay 402 communicates with UE 104b via link 416. In certain aspects, communications between relay 402 and UE 104b are beamformed, such as using one or more directional beams. For example, relay 402 may use one or more receive beams to receive signals from UE 104b, and/or one or more transmit beams to transmit signals to UE 104b. Similarly, in an example, UE 104b may use one or more receive beams to receive signals from relay 402, and/or one or more transmit beams to transmit signals to relay 402. In certain aspects, one or more of UE 104b and relay 402 may use an omni-directional beam for transmission and/or reception.

As discussed, in certain aspects, in order for UE 104b to access relay 402, the relay 402 may transmit a discovery signal. The UE 104b, when in the extended coverage area 110b of the relay 402, may receive the discovery signal and determine it is within the extended coverage area 110b of the relay 402. Accordingly, the UE 104b can transmit a message (e.g., an SOS message) to the relay 402, for the relay 402 to further send to BS 102 of the network. Such mode of operation where the relay 402 broadcasts its discovery signal without a request from UE 104b may be referred to as a relay-node triggered discovery signal or a Mode-A operation. Another mode of operation where the relay 402 transmits its discovery signal based on receiving a request from UE 104b may be referred to as a remote-device triggered discovery signal or a Mode-B operation. Certain aspects herein provide benefits for a relay-node triggered discovery signal, such as reducing the chance that the relay 402 transmits a discovery signal within a coverage area of a BS 102, such a discovery signal potentially causing interference to the coverage area of the BS 102. It should be noted, however, that the techniques here could similarly be used for a remote-device triggered discovery signal.

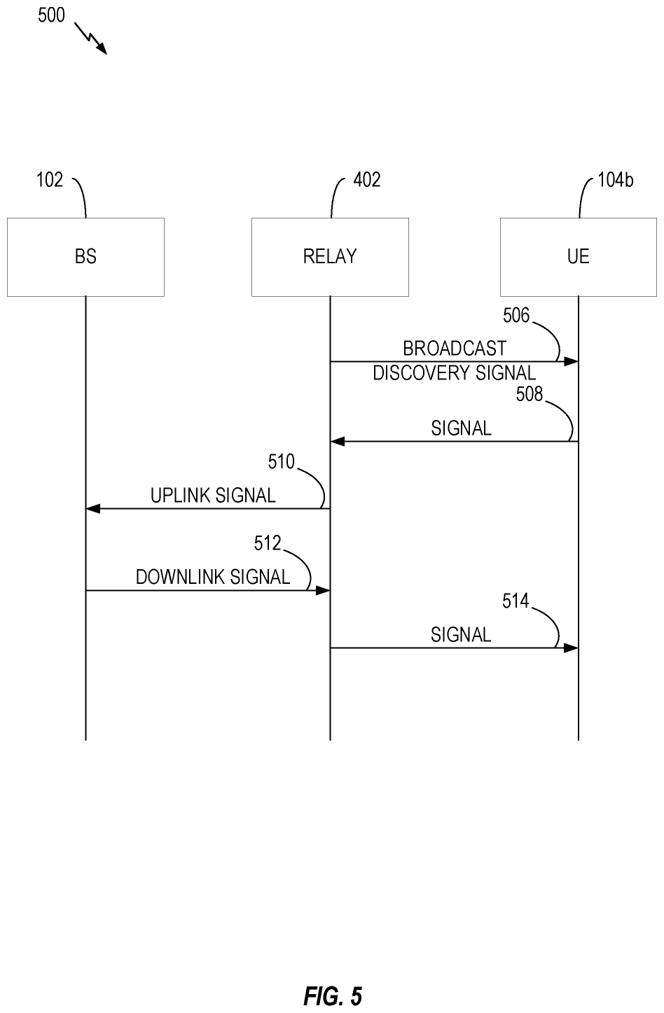

FIG. 5 illustrates a call-flow diagram 500 for communication in a network via a non-stationary relay of FIG. 4.

As shown, at step 506, relay 402 broadcasts a discovery signal, such as in extended coverage area 110a. The discovery signal may include information indicating the availability of relay 402 to provide coverage for a network to any device receiving the discovery signal. For example, the discovery signal may include one or more of: an identifier of the network, an identifier of relay 402, scheduling information for relay 402, a system information block, and/or the like. In certain aspects, such as when the relay 402 operates as a base station node or an integrated access and backhaul (IAB) node, the discovery signal comprises a synchronization signal block (SSB). In certain aspects, such as when the relay 402 operates as a UE node, the discovery signal comprises a discover message. In certain aspects, relay 402 is configured to use an omni-directional beam, or a beam covering a relatively wider area than used for communication of data on a sidelink, uplink, or downlink, for broadcasting the discovery signal. For example, an omni-directional beam or wider beam may be more likely to be received by a UE outside the coverage area of a BS 102, as the relay 402 does not have information as to the location of such a UE. Once the relay 402 has information as to the location of a UE for which it is relaying communications, it may use a relatively narrower beam for communication such data on the sidelink, downlink, and/or uplink, so as to reduce interference to other devices, and such as for power efficiency.

The UE 104b receives the broadcast discovery signal and determines that relay 402 is available for facilitating communication in the network. For example, UE 104b may determine it is within an extended coverage area 110b of the network, where coverage is provided by relay 402. The UE 104b may or may not have information that relay 402 is specifically providing said coverage in extended coverage area 110b.

For uplink communication, at step 508, the UE 104b transmits a signal (e.g., using beamforming) to relay 402. In certain aspects, the signal may be an uplink signal, such as when the relay 402 operates as a base station node or an integrated access and backhaul (IAB) node. In certain aspects, the signal may be a sidelink signal, such as when the relay 402 operates as a UE node. Further, at step 510, the relay 402 receives (e.g., using beamforming) the signal and retransmits it to BS 102 (e.g., using beamforming) as an uplink signal. The BS 102 receives the uplink signal (e.g., using beamforming).

For downlink communication, at step 512, the BS 102 transmits a downlink signal (e.g., using beamforming) to relay 402. Further, at step 514, the relay 402 receives (e.g., using beamforming) the downlink signal and retransmits it to UE 104b (e.g., using beamforming) as a downlink signal or a sidelink signal. The UE 104b receives the signal (e.g., using beamforming).

As discussed, in certain aspects, transmission of the discovery signal by relay 402 may cause interference in the coverage area of a BS 102 if the relay 402 transmits the discovery signal in the coverage area of a BS 102. Such likelihood of interference may be increased where the discovery signal is transmitted periodically and using a wide or omni-directional beam of high transmit power in an attempt to reach any potential UE that the relay 402 has no information about that may be outside of the coverage area of BS 102 but within communication range of relay 402. Further, the relay 402 may be configured to transmit the discovery signal at the same frequency as used by BSs 102 and UEs 104 in the network for cellular communication, such as to ensure any UE 104 operating on such frequency signals is able to receive the discovery signal. For example, such discovery signals may be transmitted periodically by relay 402 to provide emergency coverage to UEs outside the coverage area of a BS 102, for example for the UE to send an SOS message to the network.

Accordingly, certain aspects described herein provide techniques to reduce potential interference to a communication network caused by a relay transmitting (e.g., broadcasting) a discovery signal. In particular, in certain aspects, the relay determines whether to broadcast a discovery signal based at least in part on a geographical location of the relay, and broadcasts the discovery signal when it is determined to broadcast the discovery signal. For example, when the geographical location of the relay is over an area identified as being a geographical area without cellular coverage available, the relay may transmit the discovery signal. In another example, when the geographical location of the relay is over an area identified as being a geographical area with cellular coverage available, the relay may refrain from transmitting the discovery signal.

### Aspects of Relay Determined Discovery Signal Broadcasting

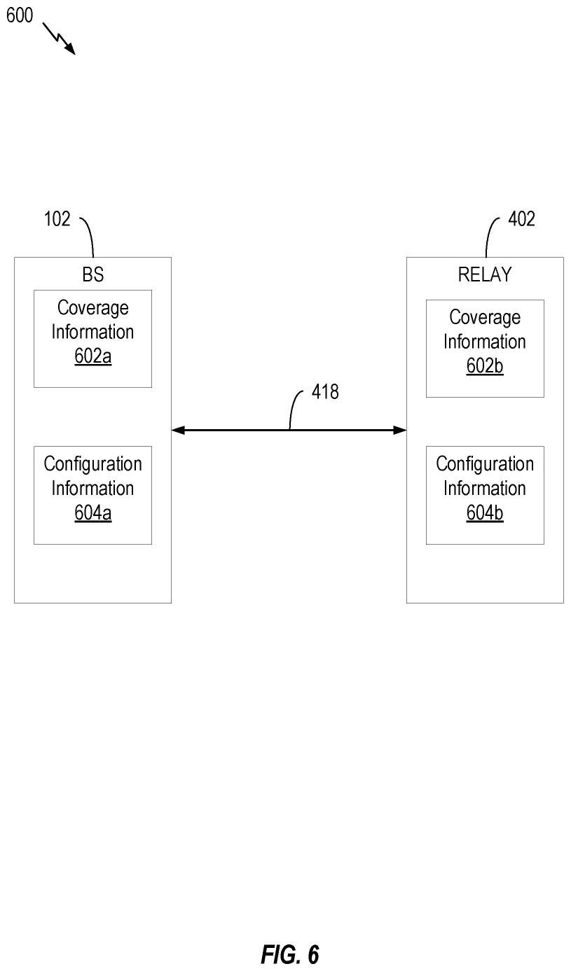

FIG. 6 is a block diagram 600 of a BS 102 and relay 402 of FIG. 4. In certain aspects, the network of BS 102 and/or the relay 402 store coverage information 602 indicating geographical areas with cellular coverage available for the network and geographical areas without cellular coverage available for the network. For example, coverage information 602b may be stored at relay 402 in one or more of: a memory of relay 402, persistent storage of relay 402, a database, memory, or storage accessible by relay 402, and/or the like. Coverage information 602a may be stored at BS 102 (or another at another location in the network that is accessible by BS 102. For example, coverage information 602b may be stored in one or more of: a memory of BS 102, a persistent storage of BS 102, a database, memory, or storage accessible by BS 102, and/or the like.

In certain aspects, the coverage information 602 includes an explicit indication of geographical areas with cellular coverage available for the network. In certain aspects, the geographical areas without cellular coverage available for the network are implicitly indicated by such explicit indication of geographical areas with cellular coverage available for the network, in that any area not explicitly indicated is assumed to be a geographical area without cellular coverage available.

In certain aspects, the coverage information 602 includes an explicit indication of geographical areas without cellular coverage available for the network. In certain aspects, the geographical areas with cellular coverage available for the network are implicitly indicated by such explicit indication of geographical areas without cellular coverage available for the network, in that any area not explicitly indicated is assumed to be a geographical area with cellular coverage available.

In certain aspects, the coverage information 602 includes an explicit indication of geographical areas without cellular coverage available for the network and an explicit indication of geographical areas with cellular coverage available for the network.

In certain aspects, an indication of a geographical area includes one or more coordinates (e.g., latitude, longitude, GPS coordinate, etc.). In certain aspects, an indication of a geographical area includes one or more measurements, such as a radius or diameter around the one or more coordinates defining the geographical area.

In certain aspects, similar to how the network of BS 102 and/or the relay 402 store coverage information 602, the network of BS 102 and/or the relay 402 store coverage information 604. In certain aspects, the configuration information 604 comprises one or more parameters for broadcasting a discovery signal for one or more geographical areas indicated in coverage information 602. For example, in certain aspects, a given geographical area without cellular coverage indicated in coverage information 602 may be associated with a corresponding set of one or more parameters, such that different geographical areas may be associated with different sets of one or more parameters. In certain aspects, different groups (e.g., all, a plurality less than all, etc.) of geographical areas without cellular coverage may be associated with different sets of one or more parameters.

In certain aspects, the one or more parameters include one or more of a transmit power, a modulation and coding scheme (MCS), a number of repetitions, beamforming information, or a time and frequency resource allocation. For example, when in a geographical area associated with a particular transmit power, the relay 402 may transmit the discovery signal at the particular transmit power. For example, when in a geographical area associated with a particular modulation and coding scheme, the relay 402 may transmit the discovery signal using the particular modulation and coding scheme. For example, when in a geographical area associated with a particular number of repetitions, the relay 402 may transmit the discovery signal repeating for the particular number of repetitions. For example, when in a geographical area associated with a particular beamforming information, the relay 402 may transmit the discovery signal using a particular beam indicated by the beamforming information. For example, when in a geographical area associated with a particular time and frequency resource allocation, the relay 402 may transmit the discovery signal using a particular set of time-frequency resources (e.g., resource blocks, resource elements, tones, symbols, carriers, slots, etc.) indicated in the time and frequency resource allocation.

As an example, geographical areas without cellular coverage that correspond to a mountain or forest terrain may be associated with a relatively higher transmit power than for example a desert terrain, as path loss of the discovery signal may be greater in a mountain or forest terrain than a desert terrain. Similarly, geographical areas without cellular coverage that correspond to a mountain or forest terrain may be associated with a relatively higher number of repetitions and/or lower MCS than for example a desert terrain.

In certain aspects, coverage information 602b and/or configuration information 604b is fully or partly (e.g., where later updated by the network) predetermined or prestored at relay 402, such as at the time of manufacture, via an over-the-air (OTA) update, etc.

In certain aspects, coverage information 602b and/or configuration information 604b is fully or partly (e.g., as part of an update from the network) received from the network at relay 402, such as from BS 102 or a satellite. In certain aspects, the coverage information 602b and/or configuration information 604b is received by relay 402 (e.g., and transmitted by BS 102) using application layer protocols or radio access network (RAN)-based signaling, such as in a radio resource control (RRC) message, a medium access control (MAC)-control element (CE), downlink control information (DCI), and/or the like.

In certain aspects, the relay 402 determines whether to transmit the discovery signal based on whether the relay 402 determines it is currently in a geographical area without coverage. For example, the relay 402 determines a current location of the relay 402, such as using a positioning system (e.g., a satellite positioning system such as GPS). In certain aspects the relay 402 estimates a current location of the relay 402, such as using a previous known location of the relay 402 and one or more of a trajectory of the relay 402, a speed of the relay 402, or a beamforming information (e.g., beamforming weights, direction, etc.) of the relay 402.

The relay 402 compares the location of the relay 402 with the coverage information 602b to determine if it is in a geographical area without coverage. If it is not, the relay 402 may refrain from transmitting a discovery signal. If the relay is in a geographical area without coverage, it may transmit a discovery signal (e.g., using one or more parameters associated with the geographical area as indicated by configuration information 604b).

### Aspects of Network Controlled Discovery Signal Broadcasting

In certain aspects, the relay 402 is configured to determine whether to transmit the discovery signal based on signaling from the network, such as from BS 102. For example, in certain aspects, the BS 102 determines whether to control the relay 402 to transmit a discovery signal or not based at least in part on a geographical location of the relay 402.

For example, the relay 402 may report one or more of location information (e.g., coordinates) of the relay 402, trajectory of the relay 402, speed of the relay 402, transmit beamforming information of the relay 402 (e.g., directions or angular-spread of a beamformer/beam of the relay 402) in a message to the BS 102, such as using RAN-based signaling.

The BS 102 may estimate or determine a location of the relay 402 based on the report from the relay 402. The BS 102 compares the location of the relay 402 with the coverage information 602a to determine if the relay 402 is in a geographical area without coverage. If it is not, the BS 102 may not signal the relay 402 to transmit a discovery signal, or may signal the relay 402 not to transmit a discovery signal. If the relay 402 is in a geographical area without coverage, the BS 102 may signal the relay 402 to transmit a discovery signal. The relay 402 may receive the control signal or message from the BS 102, or a satellite, and transmit or not transmit a discovery signal accordingly. In certain aspects, BS 102 may including in the control signal or message, based on configuration information 604a, one or more parameters for transmitting the discovery signal, and the relay 402 may transmit the discovery signal using the one or more parameters (e.g., as discussed with respect to relay determined discovery signal broadcasting). In certain aspects, the control signal or message is transmitted by BS 102 (e.g., and received by relay 402) using application layer protocols or RAN-based signaling.

### Aspects of UE Behavior Based on Discovery Signal Broadcasting

In certain aspects, UE 104b receives side information from BS 102 while in coverage area 110a of BS 102 and before UE 104b moves outside of coverage area 110a (e.g., and into extended coverage area 110b). In certain aspects, the side information indicates one or more parameters for receiving a discovery signal in one or more geographical areas without cellular coverage available. For example, in certain aspects, the side information includes one or more of: one or more frequency resources; one or more time resources; route and time information of one or more relays; beam sweeping information; or beamforming information. In certain aspects, the side information is transmitted by BS 102 (e.g., and received by UE 104b) using application layer protocols or RAN-based signaling. In certain aspects, the BS 102 is configured to transmit the side information to UE 104b at an edge of coverage area 110a, such as when the UE 104b reports a channel quality below a threshold, a location within a threshold distance of a geographical area without cellular coverage, and/or the like.

In certain aspects, UE 104b is configured to adjust its power state (e.g., adjust a sleep period of UE 104b) based on the side information while in a geographical area without cellular coverage. For example, in certain aspects, the UE 104b, based on the side information, may determine when it is likely to be within an extended coverage area of a relay, and when it is not. UE 104b may adjust its sleep periods, such that it is in a low power or sleep state when it is determined to likely not be within an extended coverage area of a relay, and such that it is in an operational state when it is determined to likely be within an extended coverage area of a relay.

### Example Methods

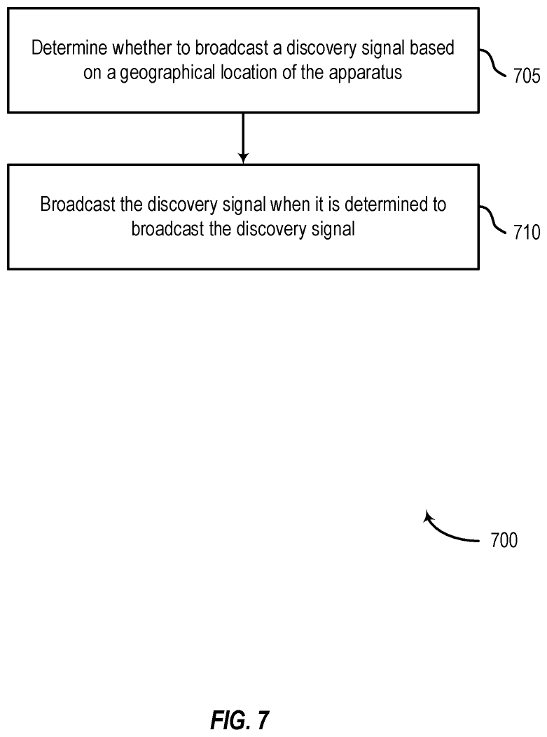

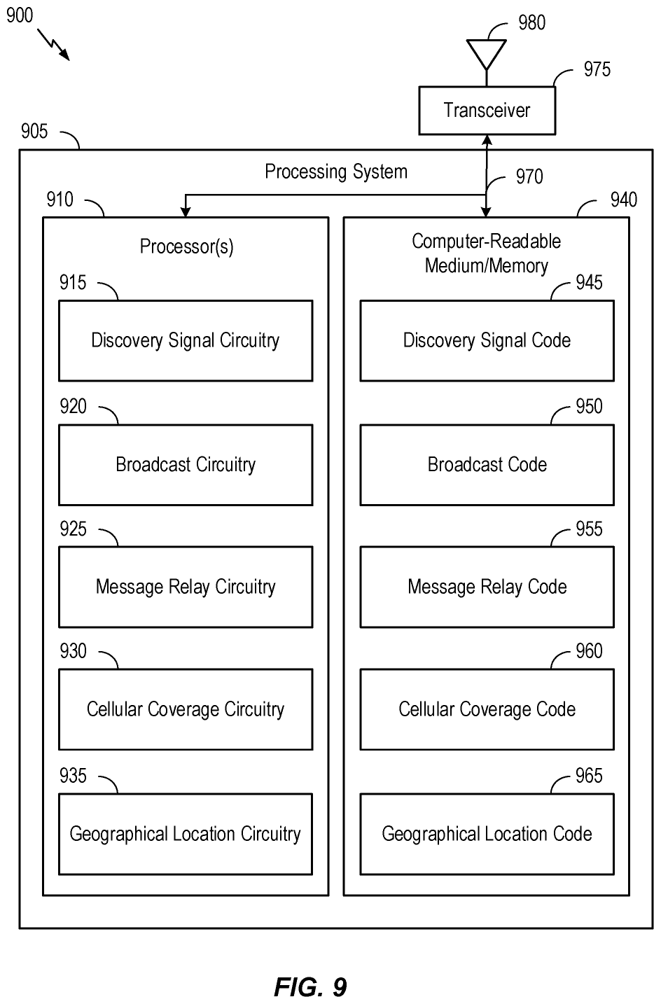

FIG. 7 shows an example of a method 700 for wireless communication according to aspects of the present disclosure. In some aspects, a relay, such as relay 402 of FIGS. 4 through 6, or processing system 905 of FIG. 9, may perform the method 700.

At operation 705, the system determines whether to broadcast a discovery signal based on a geographical location of the apparatus. In some cases, the operations of this step refer to, or may be performed by, discovery signal circuitry as described with reference to FIG. 9.

At operation 710, the system broadcasts the discovery signal when it is determined to broadcast the discovery signal. In some cases, the operations of this step refer to, or may be performed by, broadcast circuitry as described with reference to FIG. 9.

In some examples, the method 700 further includes receiving a message from a UE in response to the discovery signal. Some examples further include relaying the message to a base station.

In some aspects, the method 700 further includes storing coverage information indicating geographical areas with cellular coverage available and geographical areas without cellular coverage available. In some examples, the method 700 further includes receiving at least part of the coverage information from a base station.

In some aspects, determining whether to broadcast the discovery signal comprises determining to broadcast the discovery signal when the geographical location of the apparatus is over an area identified in the coverage information as being a geographical area without cellular coverage available. In some aspects, determining whether to broadcast the discovery signal comprises determining to not broadcast the discovery signal when the geographical location of the apparatus is over an area identified in the coverage information as being a geographical area with cellular coverage available.

In some aspects, the method 700 further includes storing configuration information indicating, for one or more of the geographical areas without cellular coverage available, one or more parameters for broadcasting the discovery signal. In some aspects, the one or more parameters comprise one or more of a transmit power, a modulation and coding scheme, a number of repetitions, beamforming information, or a time and frequency resource allocation.

In some aspects, the method 700 further includes transmitting an indication of the geographical location of the apparatus to a base station. In some aspects, the method 700 further includes receiving, from the base station, a control signal indicating whether to broadcast the discovery signal.

In some aspects, the control signal further indicates one or more parameters for broadcasting the discovery signal. In some aspects, the one or more parameters comprise one or more of a transmit power, a modulation and coding scheme, a number of repetitions, beamforming information, or a time and frequency resource allocation.

In some aspects, the discovery signal includes one or more parameters for resource allocation to a user equipment, the one or more parameters comprising one or more of a modulation and coding scheme, a number of repetitions, or a time and frequency resource allocation.

In some examples, the method 700 further includes transmitting, to the base station, one or more of a trajectory of the apparatus, a speed of the apparatus, or beamforming information of the apparatus. In some examples, determining whether to broadcast the discovery signal is further based on the one or more of the trajectory of the apparatus, the speed of the apparatus, or the beamforming information of the apparatus.

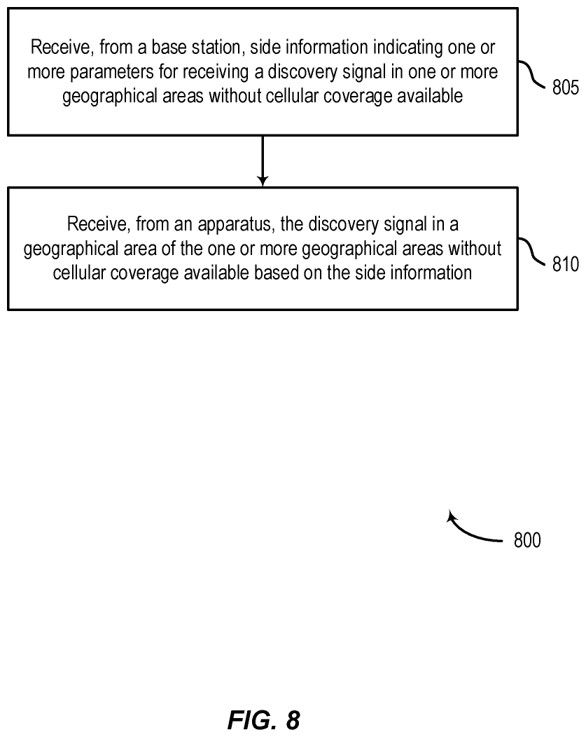

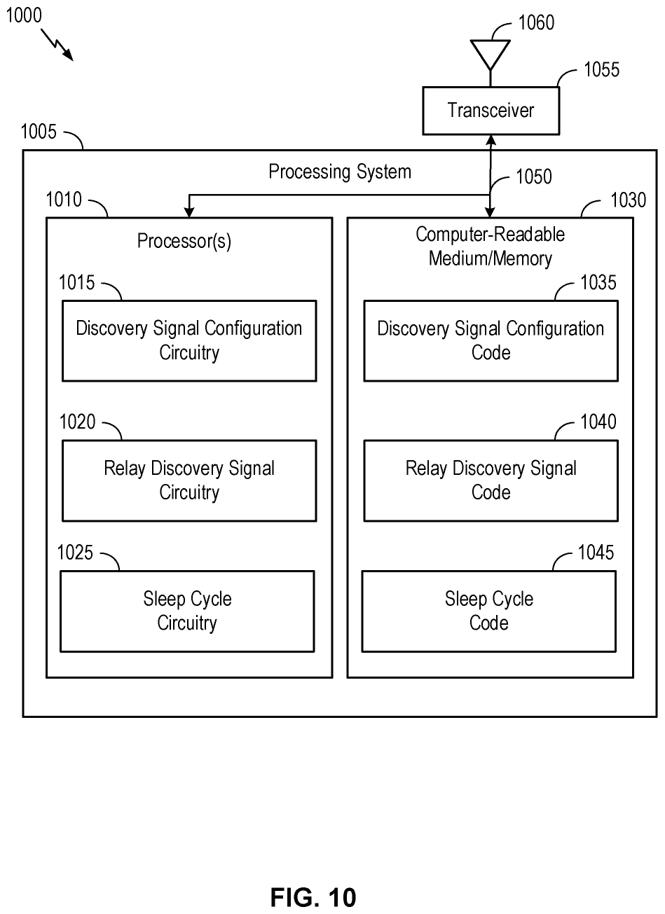

FIG. 8 shows an example of a method 800 for wireless communication according to aspects of the present disclosure. In some aspects, a user equipment, such as UE 104 of FIGS. 1 and 2, or processing system 1005 of FIG. 10, may perform the method 800.

At operation 805, the system receives, from a base station, side information indicating one or more parameters for receiving a discovery signal in one or more geographical areas without cellular coverage available. In some cases, the operations of this step refer to, or may be performed by, discovery signal configuration circuitry as described with reference to FIG. 10.

At operation 810, the system receives, from an apparatus, the discovery signal in a geographical area of the one or more geographical areas without cellular coverage available based on the side information. In some cases, the operations of this step refer to, or may be performed by, relay discovery signal circuitry as described with reference to FIG. 10.

In some aspects, the side information comprises one or more frequency resources, one or more time resources, route and time information of one or more apparatuses including the apparatus, beam sweeping information, beamforming information, or some combination thereof.

In some examples, receiving the side information comprises receiving the side information when the UE is near the geographical area of the one or more geographical areas without cellular coverage available.

In some examples, method 800 further includes adjusting a sleep period for the UE based on the side information.

### Example Wireless Communication Devices

FIG. 9 depicts an example communications device 900 that includes various components operable, configured, or adapted to perform operations for the techniques disclosed herein, such as the operations depicted and described with respect to FIGS. 4-7. In some examples, communication device may be a relay 402 as described, for example with respect to FIGS. 4 through 6.

Communications device 900 includes a processing system 905 coupled to the transceiver 975 (e.g., a transmitter and/or a receiver). The transceiver 975 is configured to transmit (or send) and receive signals for the communications device 900 via the antenna 980, such as the various signals as described herein. The transceiver 975 may communicate bi-directionally, via the antennas 980, wired links, or wireless links as described herein. For example, the transceiver 975 may represent a wireless transceiver and may communicate bi-directionally with another wireless transceiver. The transceiver 975 may also include or be connected to a modem to modulate the packets and provide the modulated packets to for transmission, and to demodulate received packets. In some examples, the transceiver 975 may be tuned to operate at specified frequencies. For example, a modem can configure the transceiver 975 to operate at a specified frequency and power level based on the communication protocol used by the modem.

Processing system 905 may be configured to perform processing functions for communications device 900, including processing signals received and/or to be transmitted by communications device 900. Processing system 905 includes one or more processors 910 coupled to a computer-readable medium/memory 940 via a bus 970.

In some examples, one or more processors 910 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 910 are configured to operate a memory array using a memory controller. In other cases, a memory controller is integrated into the one or more processors 910. In some cases, the one or more processors 910 are configured to execute computer-readable instructions stored in a memory to perform various functions. In some aspects, one or more processors 910 include special purpose components for modem processing, baseband processing, digital signal processing, or transmission processing.

In certain aspects, computer-readable medium/memory 940 is configured to store instructions (e.g., computer-executable code) that when executed by the one or more processors 910, cause the one or more processors 910 to perform the operations illustrated in FIGS. 4-7, or other operations for performing the various techniques discussed herein.

In one aspect, computer-readable medium/memory 940 includes discovery signal code 945, broadcast code 950, message relay code 955, cellular coverage code 960, and geographical location code 965.

Examples of a computer-readable medium/memory 940 include random access memory (RAM), read-only memory (ROM), solid state memory, a hard drive, a hard disk drive, etc. In some examples, computer-readable medium/memory 940 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 900 may provide means for performing the methods described herein, including with respect to FIGS. 4-7.

In some examples, means for transmitting or sending (or means for outputting for transmission) may include transceivers 232 and/or antenna(s) 234 of the base station 102 illustrated in FIG. 2, transceivers 254 and/or antenna(s) 252 of the user equipment 104 illustrated in FIG. 2, and/or the transceiver 975 and the antenna 980 of the communication device in FIG. 9.

In some examples, means for receiving (or means for obtaining) may include transceivers 232 and/or antenna(s) 234 of the base station 102 illustrated in FIG. 2, transceivers 254 and/or antenna(s) 252 of the user equipment 104 illustrated in FIG. 2, and/or the transceiver 975 and the antenna 980 of the communication device in FIG. 9.

In some examples, means for determining and/or means for broadcasting may include various processing system 905 components, such as: the one or more processors 910 in FIG. 9, aspects of the base station 102 depicted in FIG. 2, including receive processor 238, transmit processor 220, TX MIMO processor 230, and/or controller/processor 240, or aspects of the user equipment 104 depicted in FIG. 2, including receive processor 258, transmit processor 264, TX MIMO processor 266, and/or controller/processor 280.

In one aspect, one or more processors 910 includes discovery signal circuitry 915, broadcast circuitry 920, message relay circuitry 925, cellular coverage circuitry 930, and geographical location circuitry 935.

According to some aspects, discovery signal circuitry 915 determines whether to broadcast a discovery signal based on a geographical location of the apparatus. In some examples, discovery signal circuitry 915 determines to broadcast the discovery signal when the geographical location of the apparatus is over an area identified in the coverage information as being a geographical area without cellular coverage available. In some examples, discovery signal circuitry 915 determines to not broadcast the discovery signal when the geographical location of the apparatus is over an area identified in the coverage information as being a geographical area with cellular coverage available.

In some examples, discovery signal circuitry 915 stores configuration information indicating, for one or more of the geographical areas without cellular coverage available, one or more parameters for broadcasting the discovery signal. In some aspects, the one or more parameters include one or more of a transmit power, a modulation and coding scheme, a number of repetitions, beamforming information, or a time and frequency resource allocation.

In some examples, discovery signal circuitry 915 receives, from the base station, a control signal indicating whether to broadcast the discovery signal. In some aspects, the control signal further indicates one or more parameters for broadcasting the discovery signal. In some aspects, the one or more parameters include one or more of a transmit power, a modulation and coding scheme, a number of repetitions, beamforming information, or a time and frequency resource allocation. In some aspects, the discovery signal includes one or more parameters for resource allocation to a user equipment, the one or more parameters including one or more of a modulation and coding scheme, a number of repetitions, or a time and frequency resource allocation.

According to some aspects, broadcast circuitry 920 broadcasts the discovery signal when it is determined to broadcast the discovery signal.

According to some aspects, message relay circuitry 925 receives a message from a UE in response to the discovery signal. In some examples, message relay circuitry 925 relays the message to a base station.

According to some aspects, cellular coverage circuitry 930 stores coverage information indicating geographical areas with cellular coverage available and geographical areas without cellular coverage available. In some examples, cellular coverage circuitry 930 receives at least part of the coverage information from a base station.

According to some aspects, geographical location circuitry 935 transmits an indication of the geographical location of the apparatus to a base station. In some examples, geographical location circuitry 935 transmits, to the base station, one or more of a trajectory of the apparatus, a speed of the apparatus, or beamforming information of the apparatus. In some examples, determining whether to broadcast the discovery signal is further based on the one or more of the trajectory of the apparatus, the speed of the apparatus, or the beamforming information of the apparatus.

Notably, FIG. 9 is just one example, and many other examples and configurations of communication device are possible.

FIG. 10 depicts an example communications device 1000 that includes various components operable, configured, or adapted to perform operations for the techniques disclosed herein, such as the operations depicted and described with respect to FIGS. 4-6 and 8. In some examples, communication device may be a user equipment 104 as described, for example with respect to FIGS. 1 and 2.

Communications device 1000 includes a processing system 1005 coupled to the transceiver 1055 (e.g., a transmitter and/or a receiver). The transceiver 1055 is configured to transmit (or send) and receive signals for the communications device 1000 via the antenna 1060, such as the various signals as described herein. The transceiver 1055 may communicate bi-directionally, via the antennas 1060, wired links, or wireless links as described herein. For example, the transceiver 1055 may represent a wireless transceiver and may communicate bi-directionally with another wireless transceiver. The transceiver 1055 may also include or be connected to a modem to modulate the packets and provide the modulated packets to for transmission, and to demodulate received packets. In some examples, the transceiver 1055 may be tuned to operate at specified frequencies. For example, a modem can configure the transceiver 1055 to operate at a specified frequency and power level based on the communication protocol used by the modem.

Processing system 1005 may be configured to perform processing functions for communications device 1000, including processing signals received and/or to be transmitted by communications device 1000. Processing system 1005 includes one or more processors 1010 coupled to a computer-readable medium/memory 1030 via a bus 1050.

In some examples, one or more processors 1010 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1010 are configured to operate a memory array using a memory controller. In other cases, a memory controller is integrated into the one or more processors 1010. In some cases, the one or more processors 1010 are configured to execute computer-readable instructions stored in a memory to perform various functions. In some aspects, one or more processors 1010 include special purpose components for modem processing, baseband processing, digital signal processing, or transmission processing.

In certain aspects, computer-readable medium/memory 1030 is configured to store instructions (e.g., computer-executable code) that when executed by the one or more processors 1010, cause the one or more processors 1010 to perform the operations illustrated in FIGS. 4-6 and 8, or other operations for performing the various techniques discussed herein.

In one aspect, computer-readable medium/memory 1030 includes discovery signal configuration code 1035, relay discovery signal code 1040, and sleep cycle code 1045.

Examples of a computer-readable medium/memory 1030 include random access memory (RAM), read-only memory (ROM), solid state memory, a hard drive, a hard disk drive, etc. In some examples, computer-readable medium/memory 1030 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1000 may provide means for performing the methods described herein, including with respect to FIGS. 4-6 and 8.

In some examples, means for transmitting or sending (or means for outputting for transmission) may include transceivers 254 and/or antenna(s) 252 of the user equipment 104 illustrated in FIG. 2 and/or the transceiver 1055 and the antenna 1060 of the communication device in FIG. 10.

In some examples, means for receiving (or means for obtaining) may include transceivers 254 and/or antenna(s) 252 of the user equipment 104 illustrated in FIG. 2 and/or the transceiver 1055 and the antenna 1060 of the communication device in FIG. 10.

In some examples, means for receiving may include various processing system 1005 components, such as: the one or more processors 1010 in FIG. 10, or aspects of the user equipment 104 depicted in FIG. 2, including receive processor 258, transmit processor 264, TX MIMO processor 266, and/or controller/processor 280.

In one aspect, one or more processors 1010 includes discovery signal configuration circuitry 1015, relay discovery signal circuitry 1020, and sleep cycle circuitry 1025.

According to some aspects, discovery signal configuration circuitry 1015 receives, from a base station, side information indicating one or more parameters for receiving a discovery signal in one or more geographical areas without cellular coverage available. In some aspects, the side information includes one or more frequency resources, one or more time resources, route and time information of one or more apparatuses including the apparatus, beam sweeping information, beamforming information, or some combination thereof. In some examples, discovery signal configuration circuitry 1015 receives the side information includes receiving the side information when the UE is near the geographical area of the one or more geographical areas without cellular coverage available.

According to some aspects, relay discovery signal circuitry 1020 receives, from an apparatus, the discovery signal in a geographical area of the one or more geographical areas without cellular coverage available based on the side information.

According to some aspects, sleep cycle circuitry 1025 adjusts a sleep period for the UE based on the side information.

Notably, FIG. 10 is just one example, and many other examples and configurations of communication device are possible.

### Example Clauses

Implementation examples are described in the following numbered clauses:

Clause 1: A method of wireless communication by an apparatus, comprising: determining whether to broadcast a discovery signal based at least in part on a geographical location of the apparatus; and broadcasting the discovery signal when it is determined to broadcast the discovery signal.

Clause 2: The method of Clause 1, further comprising: receiving a message from a UE in response to the discovery signal. Some examples further include relaying the message to a base station.

Clause 3: The method of any one of Clauses 1 and 2, further comprising: storing coverage information indicating geographical areas with cellular coverage available and geographical areas without cellular coverage available, wherein determining whether to broadcast the discovery signal comprises: determining to broadcast the discovery signal when the geographical location of the apparatus is over an area identified in the coverage information as being a geographical area without cellular coverage available; and determining to not broadcast the discovery signal when the geographical location of the apparatus is over an area identified in the coverage information as being a geographical area with cellular coverage available.

Clause 4: The method of Clause 3, further comprising: storing configuration information indicating, for one or more of the geographical areas without cellular coverage available, one or more parameters for broadcasting the discovery signal.

Clause 5: The method of Clause 4, wherein: the one or more parameters comprise one or more of a transmit power, a modulation and coding scheme, a number of repetitions, beamforming information, or a time and frequency resource allocation.

Clause 6: The method of Clause 3, further comprising: receiving at least part of the coverage information from a base station.

Clause 7: The method of any one of Clauses 1-2, wherein determining whether to broadcast the discovery signal comprises: transmitting an indication of the geographical location of the apparatus to a base station. Some examples further include receiving, from the base station, a control signal indicating whether to broadcast the discovery signal.

Clause 8: The method of Clause 7, further comprising: transmitting, to the base station, one or more of a trajectory of the apparatus, a speed of the apparatus, or beamforming information of the apparatus, wherein determining whether to broadcast the discovery signal is further based on the one or more of the trajectory of the apparatus, the speed of the apparatus, or the beamforming information of the apparatus.

Clause 9: The method of Clause 7, wherein: the control signal further indicates one or more parameters for broadcasting the discovery signal.

Clause 10: The method of Clause 9, wherein: the one or more parameters comprise one or more of a transmit power, a modulation and coding scheme, a number of repetitions, beamforming information, or a time and frequency resource allocation.

Clause 11: The method of any one of Clauses 1-10, wherein: the discovery signal includes one or more parameters for resource allocation to a user equipment, the one or more parameters comprising one or more of a modulation and coding scheme, a number of repetitions, or a time and frequency resource allocation.

Clause 12: A method of wireless communication by a UE, comprising: receiving, from a base station, side information indicating one or more parameters for receiving a discovery signal in one or more geographical areas without cellular coverage available; and receiving, from an apparatus, the discovery signal in a geographical area of the one or more geographical areas without cellular coverage available based on the side information.

Clause 13: The method of Clause 12, wherein the side information comprises one or more of: one or more frequency resources, one or more time resources, route and time information of one or more apparatuses including the apparatus, beam sweeping information, or beamforming information.

Clause 14: The method of any one of Clauses 12 and 13, further comprising: adjusting a sleep period for the UE based on the side information.

Clause 15: The method of any one of Clauses 12-14, wherein receiving the side information comprises: receiving the side information when the UE is near the geographical area of the one or more geographical areas without cellular coverage available.

Clause 16: The method of any one of Clauses 1-15, wherein the geographical location of the apparatus comprises a geographical location of a coverage area of the apparatus.

Clause 17: A processing system, comprising: a memory and one or more processors configured to cause the processing system to perform a method in accordance with any one of Clauses 1-16.

Clause 18: A processing system, comprising various means for performing a method in accordance with any one of Clauses 1-16.

Clause 19: A non-transitory computer-readable medium storing computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may, for example, provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station.

Note that while base stations are depicted in various aspects as unitary communication devices (e.g., BS 102), base stations may be implemented in various configurations. For example, one or more components of base station may be disaggregated, including a central unit (CU), one or more distributed units (DUs), and one or more radio units (RUs). In another example, various aspects of a base station may be virtualized. More generally, a base station (e.g., BS 102) may include components that are located at a single physical location or components located at various physical locations. In examples in which a base station includes components that are located at various physical locations, the various components may each perform various functions such that, collectively, the various components achieve functionality that is similar to a base station that is located at a single physical location. In some aspects, a base station including components that are located at various physical locations may be referred to as or may be associated with a disaggregated radio access network architecture, such as an Open RAN (O-RAN) or Virtualized RAN (VRAN) architecture.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, and other aspects described herein.

In various aspects, UE 104 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and other aspects described herein.

In some aspects, a processor may be configured to perform various operations, such as those associated with the methods described herein, and output to or obtain data from another interface that is configured to transmit or receive, respectively, the data.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where Dis DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of discovery signaling in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by an apparatus, the method comprising:
determining whether to broadcast a discovery signal based at least in part on a geographical location of the apparatus; and
broadcasting the discovery signal when it is determined to broadcast the discovery signal.

2. The method of claim 1, further comprising:
receiving a message from a user equipment in response to the discovery signal; and
relaying the message to a base station.

3. The method of claim 1, further comprising:
storing coverage information indicating geographical areas with cellular coverage available and geographical areas without cellular coverage available, wherein determining whether to broadcast the discovery signal comprises:
determining to broadcast the discovery signal when the geographical location of the apparatus is over an area identified in the coverage information as being a geographical area without cellular coverage available; and
determining to not broadcast the discovery signal when the geographical location of the apparatus is over an area identified in the coverage information as being a geographical area with cellular coverage available.

4. The method of claim 3, further comprising storing configuration information indicating, for one or more of the geographical areas without cellular coverage available, one or more parameters for broadcasting the discovery signal.

5. The method of claim 4, wherein the one or more parameters comprise one or more of a transmit power, a modulation and coding scheme, a number of repetitions, beamforming information, or a time and frequency resource allocation.

6. The method of claim 3, further comprising receiving at least part of the coverage information from a base station.

7. The method of claim 1, determining whether to broadcast the discovery signal comprises:
transmitting an indication of the geographical location of the apparatus to a base station; and
receiving, from the base station, a control signal indicating whether to broadcast the discovery signal.

8. The method of claim 7, further comprising:
transmitting, to the base station, one or more of a trajectory of the apparatus, a speed of the apparatus, or beamforming information of the apparatus, wherein determining whether to broadcast the discovery signal is further based on the one or more of the trajectory of the apparatus, the speed of the apparatus, or the beamforming information of the apparatus.

9. The method of claim 7, wherein the control signal further indicates one or more parameters for broadcasting the discovery signal.

10. The method of claim 1, wherein the geographical location of the apparatus comprises a geographical location of a coverage area of the apparatus.

11. The method of claim 1, wherein the discovery signal includes one or more parameters for resource allocation to a user equipment, the one or more parameters comprising one or more of a modulation and coding scheme, a number of repetitions, or a time and frequency resource allocation.

12. A method for wireless communication by a user equipment (UE), the method comprising:
receiving, from a base station, side information indicating one or more parameters for receiving a discovery signal in one or more geographical areas without cellular coverage available; and
receiving, from an apparatus, the discovery signal in a geographical area of the one or more geographical areas without cellular coverage available based on the side information.

13. The method of claim 12, wherein the side information comprises one or more of:
one or more frequency resources;
one or more time resources;
route and time information of one or more apparatuses including the apparatus;
beam sweeping information; or
beamforming information.

14. The method of claim 12, further comprising adjusting a sleep period for the UE based on the side information.

15. The method of claim 12, wherein receiving the side information comprises receiving the side information when the UE is near the geographical area of the one or more geographical areas without cellular coverage available.

16. An apparatus comprising:
a memory; and
a processor coupled to the memory, the memory and the processor configured to cause the apparatus to:
determine whether to broadcast a discovery signal based at least in part on a geographical location of the apparatus; and
broadcast the discovery signal when it is determined to broadcast the discovery signal.

17. The apparatus of claim 16, wherein the memory and the processor are further configured to cause the apparatus to:
receive a message from a user equipment in response to the discovery signal; and
relay the message to a base station.

18. The apparatus of claim 16, wherein:
the memory is configured to store coverage information indicating geographical areas with cellular coverage available and geographical areas without cellular coverage available; and
the memory and the processor being configured to cause the apparatus to determine whether to broadcast the discovery signal comprises the memory and the processor being configured to cause the apparatus to:
determine to broadcast the discovery signal when the geographical location of the apparatus is over an area identified in the coverage information as being a geographical area without cellular coverage available; and
determine to not broadcast the discovery signal when the geographical location of the apparatus is over an area identified in the coverage information as being a geographical area with cellular coverage available.

19. The apparatus of claim 18, wherein the memory is configured to store configuration information indicating, for one or more of the geographical areas without cellular coverage available, one or more parameters for broadcasting the discovery signal.

20. A user equipment (UE) comprising:
a memory; and
a processor coupled to the memory, the memory and the processor configured to cause the UE to:
receive, from a base station, side information indicating one or more parameters for receiving a discovery signal in one or more geographical areas without cellular coverage available; and
receive, from an apparatus, the discovery signal in a geographical area of the one or more geographical areas without cellular coverage available based on the side information.
